(19) United States
(12) Patent Application Publication
(10) Pub. No.: US 2015/0253883 A1
(43) Pub. Date: Sep. 10, 2015

(54) DISPLAY DEVICE AND DISPLAY METHOD

(71) Applicant: SHARP KABUSHIKI KAISHA, Osaka-shi, Osaka (JP)

(72) Inventors: Ai Takano, Osaka-shi (JP); Takuro Mishima, Osaka-shi (JP); Naoki Kanoh, Osaka-shi (JP); Tomoko Hijikata, Osaka-shi (JP); Takayuki Suzuki, Osaka-shi (JP)

(73) Assignee: SHARP KABUSHIKI KAISHA, Osaka-shi, Osaka (JP)

(21) Appl. No.: 14/431,713

(22) PCT Filed: Aug. 27, 2013
(86) PCT No.: PCT/JP2013/072891

§ 371 Date: Mar. 26, 2015

(30) Foreign Application Priority Data
Sep. 27, 2012 (JP) 2012-213948
Sep. 27, 2012 (JP) 2012-213949
Mar. 25, 2013 (JP) 2013-062975

(51) Int. Cl. G06F 3/041; G09G 3/30

(52) U.S. Cl. CPC G06F 3/041; G09G 3/30; G09G 2380/02

(57) ABSTRACT

The problem is solved by including: a display section (2) for displaying information; a pressure sensor array section (4) constituted by a plurality of pressure sensors (3) arranged in a matrix form; and a control section (5) for controlling a speed of page turning of information to be displayed, the pressure sensor array section (4) outputting a pressure change to the control section (5) together with a position of the display device (1), the control section (5) carrying out page turning at a speed corresponding to the position.

### TECHNICAL FIELD

The present invention relates to a display device that is operable by bending displays of characters and images.

### BACKGROUND ART

A flexible display whose display portion is flexibly deformable has conventionally been proposed. The flexible display has a structure in which a luminescent material such as an organic EL element or a liquid crystal element is sandwiched between films made from plastic or the like, and is characterized by being very thin and light. Therefore, the flexible display is expected to be applicable to e-books and information carrying devices.

Patent Literature 1 discloses (i) a flexibly operable information display terminal device having a bendable display section and (ii) an information display interface. FIG. 16 is an explanatory diagram of an overall configuration of an example schematically illustrating a system of Patent Literature 1. The flexibly operable information display terminal device and the information display interface disclosed in Patent Literature 1 each include: a flexible display section 101 configured to display information; a bend sensor 104 contained in the display section 101 and configured to detect a bending amount corresponding to a bending of the display section 101; and an image display control section configured to control, in accordance with a detection output from the bend sensor 104, a scrolling speed of information to be displayed on the display section 101, wherein page turning of information is carried out at a scrolling speed corresponding to the bending amount of the display section 101.

Patent Literature 1 makes it possible to carry out page turning while freely and continuously controlling a scrolling speed in accordance with a bending amount.

### CITATION LIST

Patent Literature 1

Japanese Patent Application Publication, Tokukai, No. 2009-205565 A (Publication Date: Sep. 10, 2009)

### SUMMARY OF INVENTION

### Technical Problem

However, the flexibly operable information display terminal device and the information display interface disclosed in Patent Literature 1 are designed to change a scrolling speed of page turning in accordance with a bending angle of the display section. Although the scrolling speed is continuously adjusted, considerable skill is required to intuitively bend the display section at a bending angle corresponding to a desired scrolling speed. This is a first problem.

The present invention has been made in view of the first problem. An object of the present invention is to provide a bendable display device that is capable of changing, in accordance with a bending position of the display device, a speed of page turning of information to be displayed.

Further, the flexibly operable information display terminal device and the information display interface disclosed in Patent Literature 1 are designed to change the scrolling speed of page turning by bending the display section in a horizontal direction. Although the scrolling speed is continuously adjusted, it is not possible to carry out page turning by bending the display section in a vertical direction. This makes operation difficult. This is a second problem.

The present invention has been made in view of the second problem. An object of the present invention is to provide a bendable display device that is capable of, even in a case where the display device is bent in either a vertical or diagonal direction, carrying out page turning of information to be displayed.

### Solution to Problem

In order to solve the first problem, a display device according to one aspect of the present invention is a display device for displaying information, the display device including: a display section for displaying information; a pressure sensor array section constituted by a plurality of pressure sensors arranged in a matrix form; and a control section for controlling a speed of page turning of information to be displayed, the pressure sensor array section outputting a pressure change to the control section together with a position of the display device, the control section carrying out page turning at a speed corresponding to the position.

In order to solve the first problem, a method for a display according to one aspect of the present invention is a method for a display on a display device configured to carry out a display step of displaying information, a bending detection step of detecting a bending of a housing, and a display control step of scrolling information to be displayed, the method including the step of carrying out, at a speed corresponding to a bending position of the housing that has been detected in the bending detection step, page turning of the information to be displayed.

In order to solve the second problem, a display device according to one aspect of the present invention is a display device for displaying information, the display device including: a display section for displaying information; a pressure sensor array section constituted by a plurality of pressure sensors arranged in a matrix form; and a control section for controlling a display of information, the pressure sensor array section being capable of detecting a bending of the display device regardless of whether a bending direction of the display device is a horizontal direction, a vertical direction, or a diagonal direction, in accordance with the detection by the pressure sensor array section, the control section carrying out, in the bending direction of the display device, page turning of information to be displayed.

In order to solve the second problem, a method for a display according to one aspect of the present invention is a display method for a display on a display device configured to carry out a display step of displaying information, a bending detection step of detecting a bending of the display device, and a display control step of scrolling information to be displayed, in a case where, as a result of the detection in the bending detection step, a bending direction of the display device is a horizontal direction, a vertical direction, or a diagonal direction, the display control step carries out page turning of the information to be displayed.

### Advantageous Effects of Invention

An aspect of the present invention makes it possible to achieve a display device that is capable of changing, in accordance with a bending position of the display device, a speed of page turning of information to be displayed and that is easy to operate.

An aspect of the present invention makes it possible to achieve a display device that is capable of, even in a case where the display device is bent in either a vertical or diagonal direction, carrying out page turning of information to be displayed and that is easy to operate.

### BRIEF DESCRIPTION OF DRAWINGS

FIG. 1 is a diagram of a configuration of a main part of a display device of Embodiment 1 of the present invention.

FIG. 2 is a front view of the display device of Embodiment 1 of the present invention.

FIG. 3 is a diagram explaining how the display device of Embodiment 1 of the present invention operates.

FIG. 4 is a flow chart showing an example of how the display device of Embodiment 1 of the present invention operates.

FIG. 5 is a diagram explaining how the display device of Embodiment 1 of the present invention operates.

FIG. 6 is a diagram explaining how the display device of Embodiment 1 of the present invention operates.

FIG. 7 is a diagram explaining how a display device of Embodiment 2 of the present invention operates.

FIG. 8 is a flow chart showing an example of how the display device of Embodiment 2 of the present invention operates.

FIG. 9 is a diagram explaining how the display device of Embodiment 2 of the present invention operates.

FIG. 10 is a diagram explaining how the display device of Embodiment 2 of the present invention operates.

FIG. 11 is a diagram explaining how a display device of Embodiment 3 of the present invention operates.

FIG. 12 is a set of diagrams (a) and (b) schematically illustrating a configuration of a display device of Embodiment 4 of the present invention, (a) being a front view of the display device, (b) being a back view of the display device.

FIG. 13 is a flow chart showing an example of how the display device of Embodiment 4 of the present invention operates.

FIG. 14 is a diagram explaining how a display device of Embodiment 5 of the present invention operates.

FIG. 15 is a flow chart showing an example of how the display device of Embodiment 5 of the present invention operates.

FIG. 16 is an overall view of a configuration of a conventional flexibly operable information processing device.

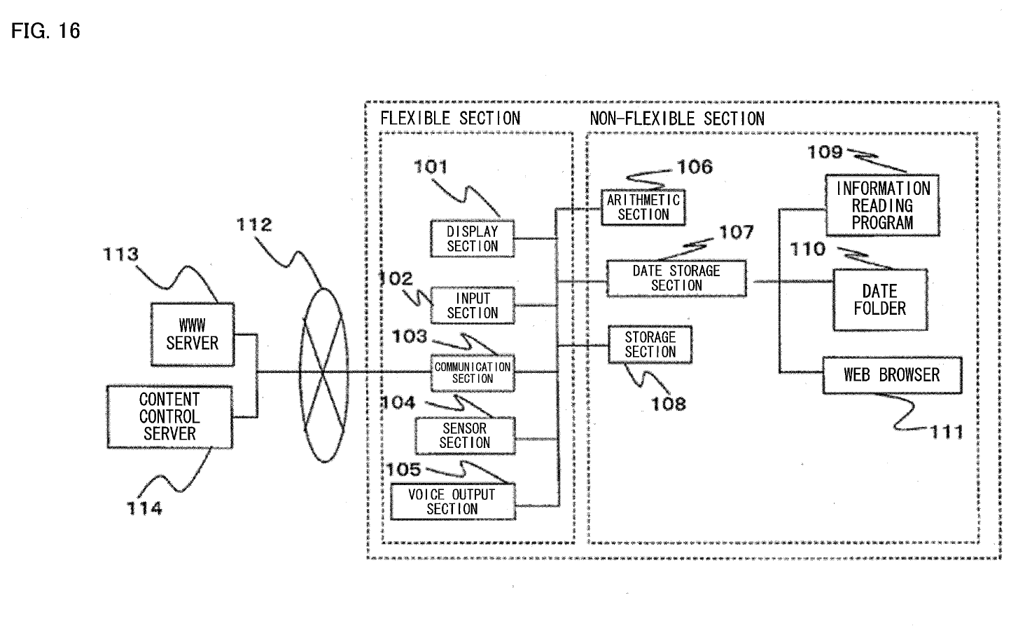

### DESCRIPTION OF EMBODIMENTS

### Embodiment 1

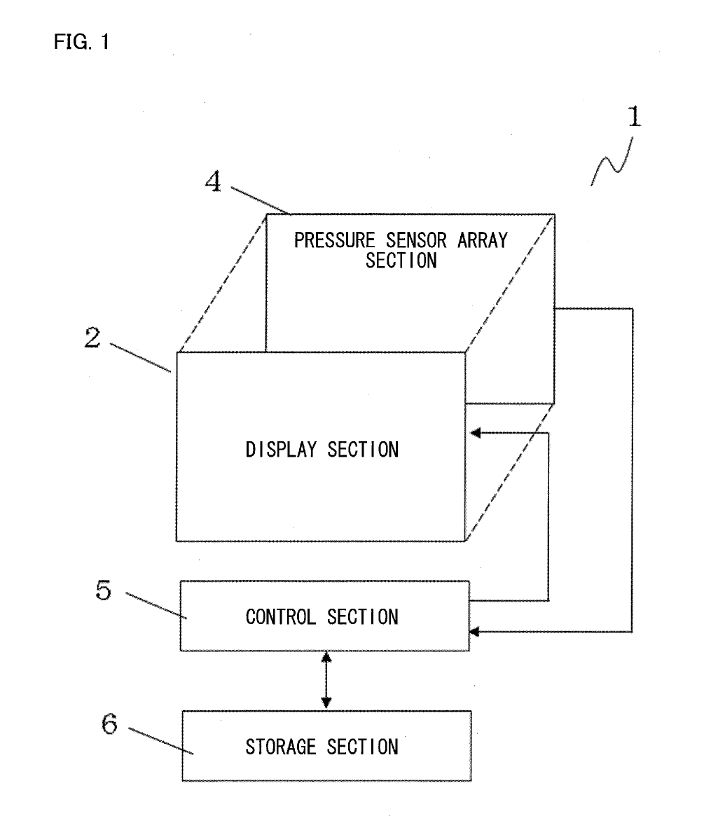

The following discusses a display device 1 of Embodiment 1 of the present invention with reference to FIGS. 1 through 5. FIG. 1 is a diagram of a configuration of a main part of an invention directed to the display device 1 of Embodiment 1. As illustrated in FIG. 1, the display device 1 of Embodiment 1 includes: a display section 2 for displaying characters, images, etc.; a pressure sensor array section 4 having a matrix arrangement of a plurality of pressure sensors each of which detects a pressure on a surface of the display section 2; a control section 5 for controlling each of the sections of the display device 1, including the display section 2 and the pressure sensor array section 4; and a storage section 6 in which image data (such as e-books, still images, and moving images) to be displayed on the display section 2 and a software program are stored.

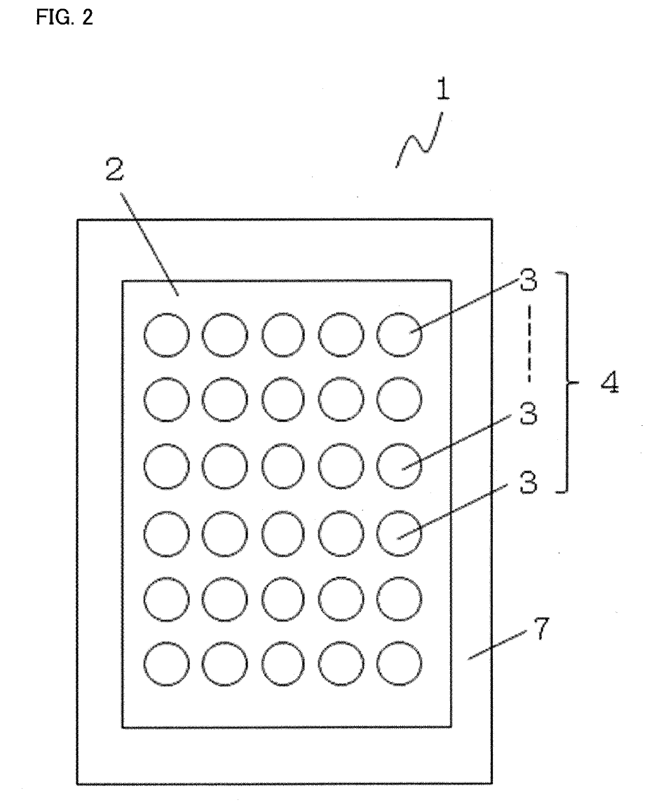

FIG. 2 is a front view of the display device 1 of Embodiment 1 of the present invention. The display device 1 of Embodiment 1 includes a substrate 7 housing the display section 2, the pressure sensor array section 4, in which pressure sensors 3 are arranged in a matrix form, and an electronic component including the control section 5. The substrate 7 is made from plastic or the like. For example, as illustrated in FIG. 2, the pressure sensor array section 4 has pressure sensors 3 arranged in six rows and five columns. In practice, the pressure sensor array section 4 has an arrangement of a larger number of pressure sensors 3 and can therefore finely detect a pressure change on the surface of the display section 2.

The display device of Embodiment 1 is configured such that in a case where the display device 1 is bent by a user, (i) the pressure sensor array section 4 detects the bending position, and (ii) page turning of the content being displayed on the display section 2 is carried out at a speed determined in advance in accordance with the bending position.

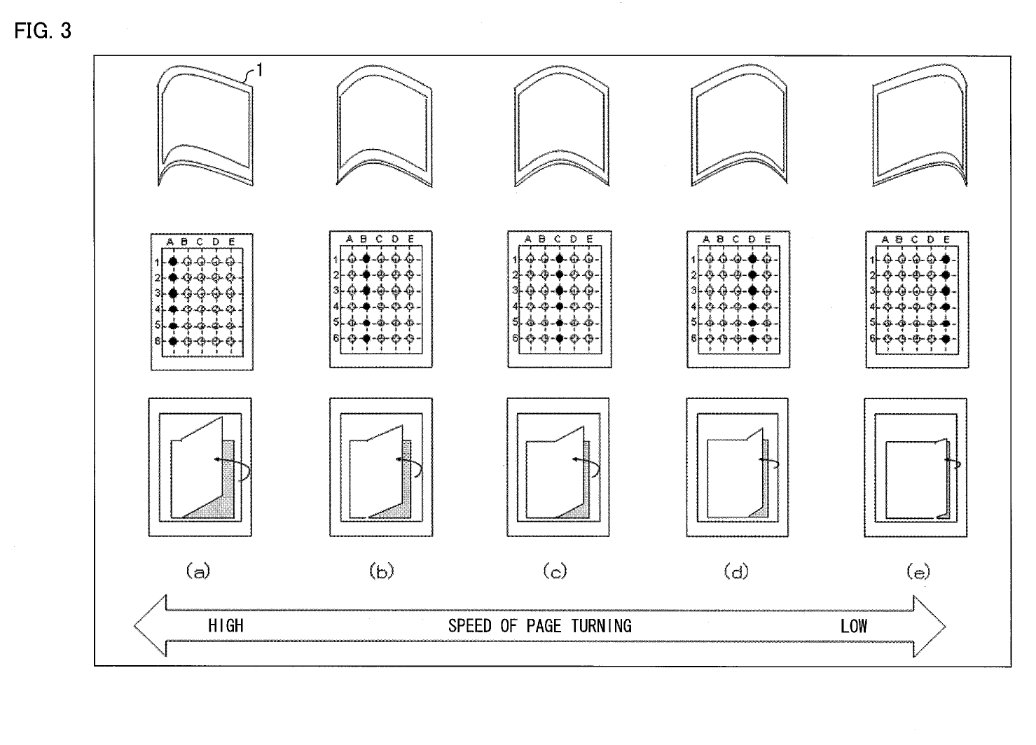

FIG. 3 is a diagram explaining how the display device of Embodiment 1 of the present invention operates. The upper row of FIG. 3 illustrates how the display device 1 is being bent by the user. The middle row of FIG. 3 illustrates a state in which the pressure sensor array section 4 is detecting a pressure in a case where the display device 1 is bent as illustrated in the upper row of FIG. 3. In the middle row of FIG. 3, for descriptive purposes, the six rows of the matrix of the pressure sensor array section 4 are denoted by reference signs 1 to 6, respectively, and the five columns of the matrix are denoted by reference signs A to E, respectively. Black circles denote a state in which the corresponding pressure sensors 3 are detecting a predetermined pressure, while white circles denote a state in which the corresponding pressure sensors 3 are not detecting a predetermined pressure. The lower row of FIG. 3 illustrates how a page of an e-book being displayed on the display section 2 of the display device 1 is turned.

The following further discusses FIG. 3. FIG. 3 illustrates how a horizontally-written e-book is displayed. In a case where the user bends the display device 1 at the position closest to a left edge of the display device 1, the pressure sensors in rows 1 to 6 in column A detect a predetermined pressure, and then are turned on as illustrated in (a) of FIG. 3. The pressure sensor array section 4 detects the pressure sensors having been turned on, and then detects the bending at the position closest to the left edge of the display device 1. Upon receiving a detection result from the pressure sensor array section 4, the control section 5 controls the display section 2 so that a speed of page turning of information, such as an e-book, is at its maximum. At this time, the page turning of contents is displayed in such a manner that the right side of the bending position of the display device is turned. This expresses an operation of turning a page of a paper book. Usually, an attempt to slowly turn a page of a horizontally-written and left-bound paper book is made by performing an operation of quickly turning a wide width from a right edge to a left edge of the book. The display device 1 of Embodiment 1 carries out such a display that the right side of the bending position of the display device 1 is turned, thereby achieving visually natural page turning.

In a case where the user bends the display device 1 at the position closest to a right edge of the display device 1, the pressure sensors in rows 1 to 6 in column E detect a predetermined pressure, and then are turned on as illustrated in (e) of FIG. 3. The pressure sensor array section 4 detects the pressure sensors having been turned on, and then notifies the control section 5 of the bending at the position closest to the right edge of the display device 1. Upon receiving the detection result from the pressure sensor array section 4, the control section 5 controls the display section 2 so that the speed of page turning of information, such as an e-book, is at its minimum. At this time, in the same manner as in (a) of FIG. 3, the page turning of content is displayed in such a manner that the right side of the bending position of the display device 1 is turned. This expresses an operation of turning a page of a paper book. Usually, an attempt to slowly turn a page of a horizontally-written and left-bound paper book is made by performing an operation of slowly turning a narrow width of the right edge of the book. The display device 1 of Embodiment 1 carries out such a display that the right side of the bending position of the display device 1 is turned, thereby achieving visually natural page turning.

Further, even in a case where the user bends the display device at a position around the center of the display device, the pressure sensors corresponding to a bending position detect a predetermined pressure, and then are turned on as illustrated in (b) and (d) of FIG. 3. Therefore, the pressure sensor array section 4 detects the bending position, and the control section 5 controls the speed of page turning of the display section 2. At this time, the speed of page turning is controlled to be faster as the bending position extends from the right edge to the left edge. In this case, too, the page turning of content is displayed is such a manner that the right side of the bending position of the display device 1 is turned.

Note that FIG. 3 shows, as an example, a case where a horizontally-written e-book is displayed. However, in a case where a vertically-written e-book is displayed, the page turning of content is displayed in such a manner that the left side of the bending position is turned at a speed determined in advance in accordance with the bending position.

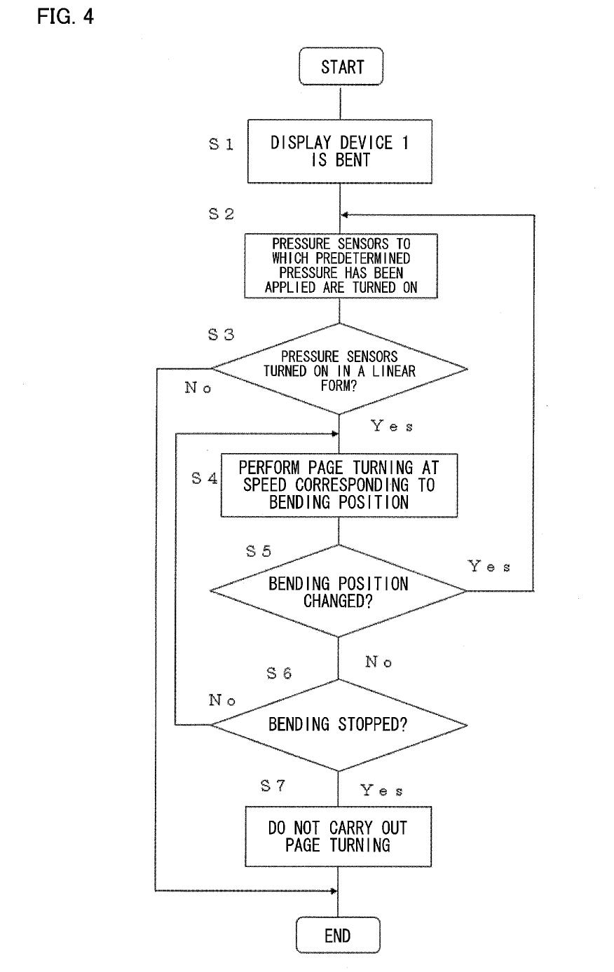

FIG. 4 is a flow chart showing an example of how the display device 1 of Embodiment 1 of the present invention operates. The operation of the display device 1 of Embodiment 1 as shown in FIG. 4 is described with reference to FIGS. 1 and 3. Note that in a flow chart of the present application, S denotes a step. Note also that FIG. 4 shows an example where a user who has already read the displayed e-book up to a certain page but does not remember the specific number of the page looks for the unread place while turning pages and starts reading.

The user starts the display device 1 of Embodiment 1, and then the display section 2 displays content such as an e-book stored in the storage section 6 (START in FIG. 4). For example, when the user bends the display device 1 as illustrated in (d) of FIG. 3 so as to carry out page turning (S1), a pressure is applied to each of the pressure sensors 3 in D1 to D6 in the pressure sensor array section 4 of the display device 1, and then each of pressure sensors 3 outputs ON when the pressure applied thereto exceeds a predetermined value (S2). Then, the pressure sensor array section 4 detects ON received from the pressure sensors 3. In a case where the pressure sensors 3 turned ON are in a linear form, the pressure sensor array section 4 detects and outputs the state to the control section 5 (Yes in S3). On the other hand, in a case where the pressure sensors 3 turned ON are not in a linear form (No in S3), the pressure sensor array section 4 terminates the flow. FIG. 4 is a flow chart of a process for page turning.

The control section 5 receives the bending position of the display device 1 from the pressure sensor array section 4 in Step S3, and then controls the display section 2 to start to carry out page turning at a speed determined in advance in accordance with the bending position (S4). In a case where the user changes the bending position of the display device 1 to the left edge as illustrated in (a) of FIG. 3 so as to increase the speed of page turning (Yes in S5), each of the pressure sensors 3 in A1 to A6 in the pressure sensor array section 4 of the display device 1 outputs ON (S2). Then, the pressure sensor array section 4 detects a change in bending position of the display device 1. At this time, since the pressure sensors 3 turned on are in a linear form (Yes in S3), page turning is carried out at a speed determined in accordance with a case where the bending position of the display device 1 is the left edge (S4).

When the user of the display device 1 finds the target page and then spreads the display device 1 open (flat) (Yes in S6), all of the pressure sensors 3 are turned off. Then, the display device 1 stops the page turning (S7), and terminates the flow. Then, the user of the display device 1 starts reading from the page at which the page turning has been stopped.

Note that in the example above, the bending position of the display device 1 is described as the position at which the pressure sensors 3 are turned on in a linear form. The clause “the pressure sensors 3 are turned on in a linear form” means that all sensors in the same column are turned on, as in the case taken as an example above where the pressure sensors in D1 to D6 are turned on. That is, in a case where only the pressure sensors in D1 to D3 are turned on, this state does not mean that the pressure sensors are turned on in a linear form. However, the bending position of the display device 1 of the present application is not limited to the position at which the pressure sensors 3 are turned on in a linear form. That is, in FIG. 3, in a case where only the sensors in E1 to E3 are turned on, it is also possible to carry out page turning at the same speed as that at which page turning is carried out in case where the sensors in E1 to E6 are turned on in a linear form. Meanwhile, it is also possible to set the display device 1 so that unless the sensors are turned on in a linear form, it is not determined the display device 1 is bent.

An increase in the number of matrices in the pressure sensor array section 4 may cause plural columns of sensors to be turned on. In this case, the bending position of the display device 1 may be the middle column of the plural columns of sensors turned on, or may be a column at either the right or left edge.

The following discusses page turning and page returning of the display device 1 of Embodiment 1. In accordance with a bending direction, the display device 1 of Embodiment 1 changes between page turning and page returning of the content to be displayed. In a case where the user bends the display device 1 into right and left, there are two directions in which the display device 1 bends, namely (i) a direction in which the user bends the display device 1 so that the right and left edges of the display device 1 move away from the user and (ii) a direction in which the user bends the display device 1 so that the right and left edges of the display device 11 move toward the user. The direction in which the user bends the display device 1 away from him/her can also be expressed as a direction in which the display device 1 curved toward the user. Meanwhile, the direction in which the user bends the display device 1 toward him/her can also be expressed as a direction in which the display device 1 is curved away from the user. The pressure sensor array section 4 detects such a bending direction.

In FIG. 3 described above, the user bends the display device 1 so that the right and left edges of the display device 1 move away from the user, and then the display device 1 carries out page turning of content at a speed corresponding to the bending position.

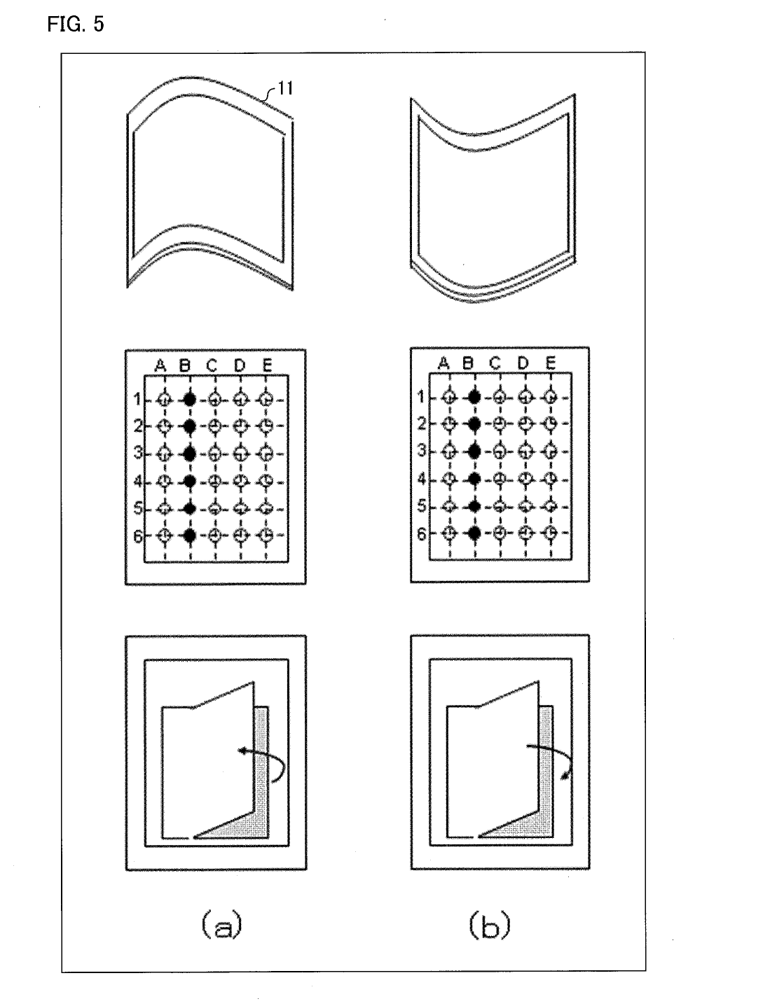

FIG. 5 is a diagram explaining page turning and page returning of the display device 1 of Embodiment 1. In the display device of Embodiment 1, the pressure sensor array section 4 detects a direction in which the display device 1 bends, and in accordance with the bending direction, changes between page turning and page returning of the content to be displayed. For example, in a case where the user bends the display device 1 of Embodiment 1 so that the right and left edges of the display device 1 move away from the user as illustrated in (a) of FIG. 5, the display device 1 carries out page turning of the content. On the other hand, in a case where the user bends the display device 1 of Embodiment 1 so that the right and left edges of the display device 1 move toward the user, the display device 1 carries out page returning of the content. That is, the pressure sensor array section 4 detects the bending direction and the bending position. In accordance with the bending direction and the bending position as detected by the pressure sensor array section 4, the control section 5 carries out, at a predetermined speed, page turning or page returning of the content being displayed on the display section 2.

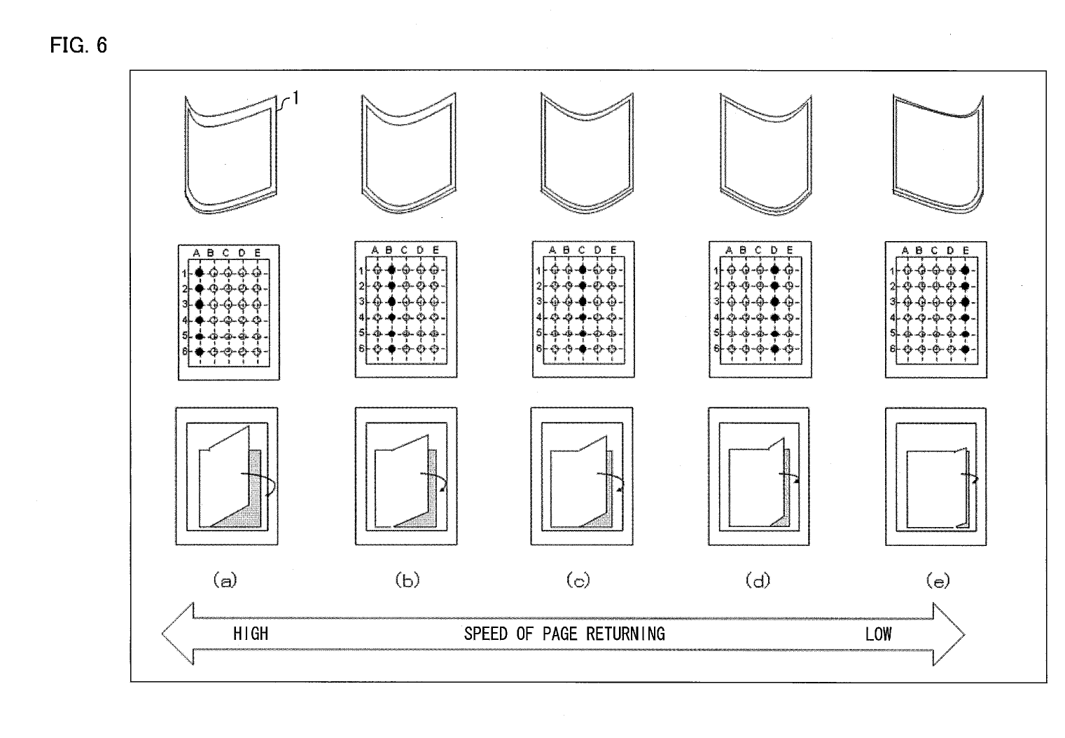

FIG. 6 is a diagram explaining the operation of page returning of the display device 1 of Embodiment 1 in more detail. In a case where the user bends the display device 1 so that the right and left edges of the display device 1 move toward the user, the display device 1 carries out page returning of content at a speed corresponding to the bending position.

As illustrated in (a) of FIG. 6, in a case where the user bends the display device 1 with the left edge as the fulcrum so that the right and left edges of the display device 1 move toward the user, the pressure sensors in rows 1 to 6 in column A detect a predetermined pressure, and then are turned on. Therefore the pressure sense array section 4 detects the bending direction and the sensors having been turned on, and then detects the bending at the position closest to the left edge of the display device 1. Upon receiving a detection result from the pressure sensor array section 4, the control section 5 controls the display section 2 so that a speed of page returning of information, such as an e-book, is at its maximum.

As illustrated in (e) of FIG. 6, in a case where the user bends the display device 1 with the right edge as the fulcrum so that the right and left edges of the display device 1 move away from the user, the pressure sensors in rows 1 to 6 in column E detect a predetermined pressure, and then are turned on. The pressure sensor array section 4 detects the bending direction and the sensors having been turned on, and then detects the bending at the position closest to the right edge of the display device 1. Upon receiving the detection result from the pressure sensor array section 4, the control section 5 controls the display section 2 so that the speed of page returning of information, such as an e-book, is at its minimum.

As illustrated in (a) to (e) of FIG. 6, as a position on the display device 1 that is bent by the user come closer to the left edge of the display device 1, the control section 5 controls the display section 2 so that the speed of page returning is higher. On the other hand, as the position on the display device 1 that is bent by the user comes closer to the right edge of the display device 1, the control section 5 controls the display section 2 so that the speed of page returning is lower.

As described above, the display device 1 according to Embodiment 1 of the present invention is configured such that in a case where the display device 1 is bent by a user, page turning is carried out at a speed determined in advance in accordance with the bending position. Further, the display device 1 of Embodiment 1 of the present invention is capable of changing, in accordance with the bending position, the speed of page turning of information to be displayed. Therefore, the display device 1 is easy to operate.

### Embodiment 2

The following discusses a display device 11 of Embodiment 2 of the present invention with reference to FIGS. 1, 2, 7 and 8. A configuration of a main part of an invention directed to the display device 11 of Embodiment 2 is the same as that of the display device 1 of Embodiment 1, and can be carried out with reference to FIG. 1.

The display device 1 of Embodiment 1 is configured such that in a case where the display device 1 is bent by the user in a horizontal direction, the pressure sensor array section 4 detects the bending position and the control section 5 carries out, at a speed determined in advance in accordance with the bending position, page turning of content being displayed on the display section 2. On the other hand, the display device 11 of Embodiment 2 is capable of carrying out page turning of content in a bending direction regardless of whether the display device 11 is bent in a horizontal direction, a vertical direction, or a diagonal direction.

The pressure sensor array section 4 of the display device 11 of Embodiment 2 has a matrix arrangement of pressure sensors 3 and can therefore detect whether the display device 1 has been bent in a horizontal direction, a vertical direction, or a diagonal direction. The display device 11 of Embodiment 2 is described below by taking, as an example, a case (see FIG. 2) where the pressure sensor array section 4 has pressure sensors 3 arranged in six rows and five columns.

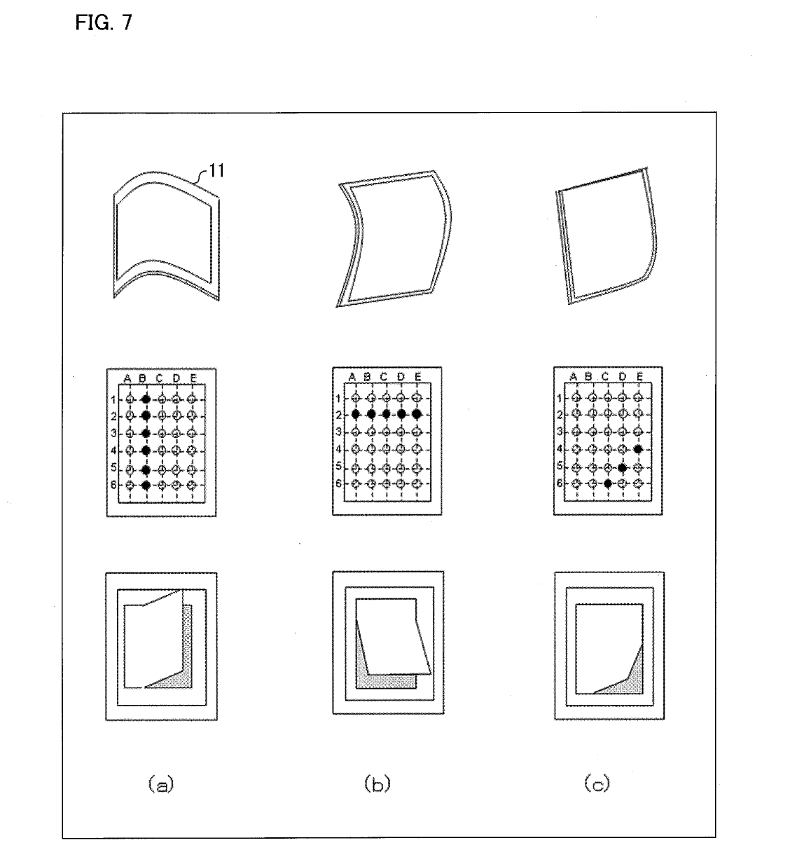

FIG. 7 is a diagram explaining how the display device 11 of Embodiment 2 of the present invention operates. The upper row of FIG. 7 illustrates how the display device 11 is being bent by the user. The middle row of FIG. 7 illustrates a state in which the pressure sensor array section 4 is detecting a pressure in a case where the display device 11 is bent as illustrated in the upper row of FIG. 7. In the middle raw of FIG. 7, for descriptive purposes, the six rows of the matrix of the pressure sensor array section 4 are denoted by reference signs 1 to 6, respectively, and the five columns of the matrix are denoted by reference signs A to E, respectively. Black circles denote a state in which the corresponding pressure sensors 3 are detecting a predetermined pressure, while white circles denote a state in which the corresponding pressure sensors 3 are not detecting a predetermined pressure. The lower row of FIG. 7 illustrates how a page of an e-book being displayed on the display section 2 of the display device 11 is turned. (a) of FIG. 7 illustrates how page turning of content is carried out in a case where the display device 11 is bent in a horizontal direction. (b) of FIG. 7 illustrates how page turning of content is carried out in a case where the display device 11 is bent in a vertical direction. (c) of FIG. 7 illustrates how page turning of content is carried out in a case where the display device is bent in a diagonal direction.

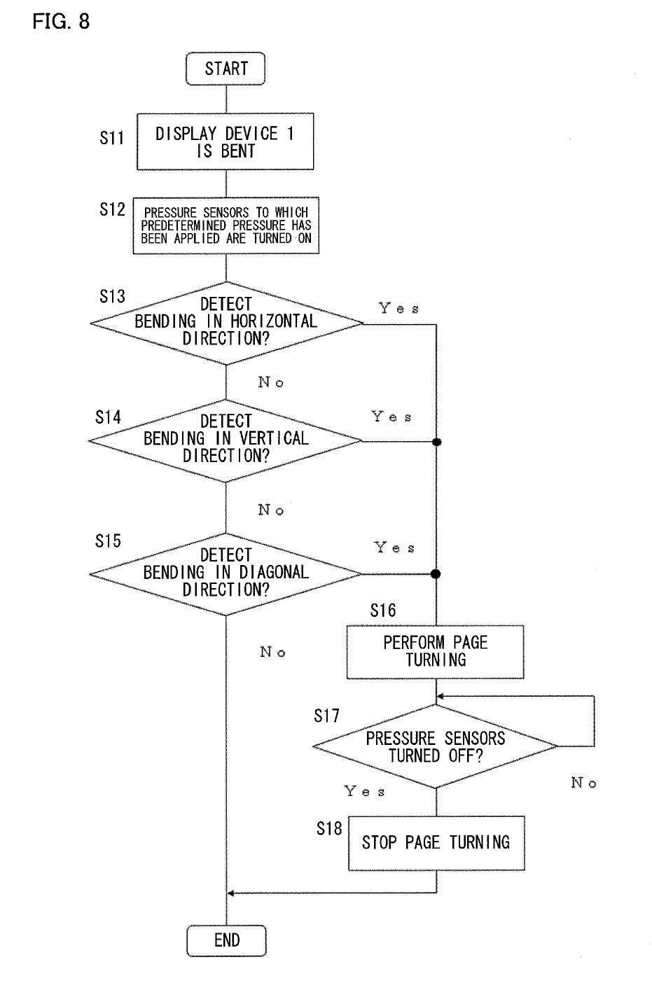

FIG. 8 is a flow chart showing an example of how the display device 11 of Embodiment 2 of the present invention operates. The operation of the display device 11 of Embodiment 2 as shown in FIG. 8 is described with reference to FIGS. 1 and 7. Note that in a flow chart of the present application, S denotes a step. Note also that FIG. 8 shown an example where a user who has already read the displayed e-book up to a certain page but does not remember the specific number of the page looks for the unread place while turning pages and starts reading.

The user starts the display device 11 of Embodiment 2, and then the display section 2 displays content such as an e-book stored in the storage section 6 (START in FIG. 8). When the user bends the display device 11 (S11), the pressure sensor array section 4 detects the bending direction of the display device 1 in accordance with Steps S12 to S15.

In (a) of FIG. 7, a horizontally-written e-book is displayed. In the case of (a) of FIG. 7, the pressure sensors 3 in B1 to B6 are turned on (S12). Accordingly, the pressure sensor array section 4 detects the turning on of all of the pressure sensors 3 in one column, determines that the display device 1 is bent in a horizontal direction, and then sends output to the control section 5 (Yes in S13). Upon receiving the bending of the display device 11 in the horizontal direction from the pressure sensor array section 4 in Step S13, and the control section 5 controls the display section 2 to start to carry out page turning in the bending direction (S16). At this time, as illustrated in the lower row of (a) of FIG. 7, the display section 2 carries out such a display that the right side of the displayed contents with respect to the bending position of the display device 11 is turned. Note that the horizontally-written e-book corresponds to a horizontally-written and left-bound paper book. Thus, in a case where the display device 11 is bent in a horizontal direction while displaying a horizontally-written e-book, the display device 11 carries out such a display that the right side of the bending position is turned, thereby achieving visually natural page turning that is similar to the turn of a page of a paper book by hand. When the user of the display device 1 turns the target page and then spreads open the display device 11 that has previously been folded, the pressure sensors 3 are turned off (Yes in S17). Therefore, the display device 11 stops the page turning (S18), and then terminates the flow. Then, the user of the display device 11 starts reading from the page at which the page turning has been stopped.

Note that (a) of FIG. 7 shows, as an example, a case where a horizontally-written e-book is displayed. However, in a case where a vertically-written e-book is displayed and the display device 11 is bent in a horizontal direction, the display device 11 carries out such a display that a left side of the bending position is turned. The vertically-written e-book corresponds to a vertically-written and right-bound paper book. Thus, in a case where the display device 11 is bent in a horizontal direction while displaying a vertically-written e-book, the display device 11 carries out such a display that the left side of the bending position is turned, thereby achieving visually natural page turning that is similar to the turn of a page of a paper book by hand.

In (b) of FIG. 7, a vertically-written or horizontally-written e-book is displayed. In the case of (b) of FIG. 7, the pressure sensors 3 in A2, B2, C2, D2, and E2 in the pressure sensor array section 4 of the display device 11, i.e. the pressure sensors in the second row, are turned on (S12). Accordingly, the pressure sensor array section 4 detects the turning on of all of the pressure sensors 3 in one row, determines that the display device 11 is bent in a vertical direction, and then sends output to the control section 5 (No in S13 and Yes in S14). Upon receiving the bending of the display device 11 in the vertical direction from the pressure sensor array section 4 in Step S14, and the control section 5 controls the display section 2 to start to carry out page turning in the bending direction (S16). At this time, as illustrated in the lower row of (b) of FIG. 7, the display section 2 carries out such a display that the lower side of the displayed content with respect to the bending position of the display device 11 is turned. This is because, in a case where the display device 11 is bent in a vertical direction and carries out page turning in the bending direction, the display device 11 turns the lower side of the bending position, thereby achieving visually natural page turning that is similar to the turn of a page of an upper-bound paper book by hand. Step S16 and the subsequent steps are the same as those described with reference to (a) of FIG. 7, and as such are not described here.

In (c) of FIG. 7, a vertically-written or is horizontally-written e-book is displayed. In the case of (c) of FIG. 7, the pressure sensors 3 in E4, D5 and C6 in the pressure sensor array section 4 of the display device are turned on (S12). Accordingly, the pressure sensor array section 4 detects the turning on of the pressure sensors 3 arranged at a predetermined angle with respect to the length or breadth of the display device 11, determines that the display device 11 is bent in a diagonal direction, and then sends output to the control section 5 (No in S13 and S14 and Yes in S15). Upon receiving the bending of the display device 11 in the diagonal direction from the pressure sensor array section 4 in Step S14, and the control section 5 controls the display section 2 to start page turning (S16). At this time, as illustrated in the lower row of (c) of FIG. 7, the display section 2 carries out such a display that the lower side of the displayed content with respect to the bending position of the display device 1 is turned. This is because, in a case where the display device 11 is bent in a diagonal direction and carries out page turning in the bending position, the display device 11 turns the lower side of the bending position, thereby achieving visually natural page turning that is similar to the turn of a page of an upper-left-bound paper book by hand. Step S16 and the subsequent steps are the same as those described with reference to (a) of FIG. 7, and as such, are not described here.

The pressure sensor array section 4 mounted in the display device 11 of Embodiment 2 detects the bending of the display device 11 by arranging the pressure sensors 3 in a matrix form. Therefore, the pressure sensor array section 4 can detect the bending of the display device 11 regardless of whether the display device 11 is bent in a horizontal direction, a vertical direction, or a diagonal direction. Thus, the display device 11 is capable of associating page turning of content with the bending of the display device 11. Regardless of whether the display device 11 is bent in a horizontal direction, a vertical direction, or a diagonal direction, the display device 11 can carry out page turning of content in the bending direction. This makes it possible to enhance the convenience of the display device.

In the example above, a criterion for determining whether the display device 11 is bent is described, for example, as a case where all of the pressure sensors 3 in column B are turned on as illustrated in (a) of FIG. 3. This is because an erroneous determination by the display device 1 can be better suppressed by determining that the display device 1 is bent in a case where all the pressure sensors 3 in column B are turned on than in a case where some of the pressure sensors 3 in column B are turned on. However, the determination of the bending position of the display device 1 of the present application is not limited to this example. It is also possible to determine that the display device 1 is bent in a case where some of the pressure sensors 3 in one column are turned on. Further, an increase in the number of matrices in the pressure sensor array section 4 may cause plural columns of sensors to be turned on. In this case, the pressure sensor array section 4 may determine whether the bending position of the display device 11 is the middle column of the plural columns of sensors turned on or a column at either of the right or left edge.

FIG. 5 is a diagram explaining page turning and page returning of the display device 1 of Embodiment 1. In the same manner as the display device 1, the display device 11 of Embodiment 2 is also capable of switching between page turning and page returning. More specifically, the pressure sensor array section 4 detects a direction in which the display device 11 bends, and in accordance with the bending direction, changes between page turning and page returning of the content to be displayed. For example, in a case where the user bends the display device 11 so that the right and left edges of the display device 11 move away from the user (See (a) of FIG. 5), the control section 5 carries out page turning of the content. On the other hand, in a case where the user bends the display device 11 so that the right and left edges of the display device 11 move toward the user (See (b) of FIG. 5), the control section 5 carries out page returning of the content. Even in a case where the display device 11 is bent in either a vertical or diagonal direction, as in the case where the display device 11 is bent in a horizontal direction, the control section 5 carries out page turning when the user bends the display device 11 away from him/her, and carries out page returning when the user bends the display device 11 toward him/her.

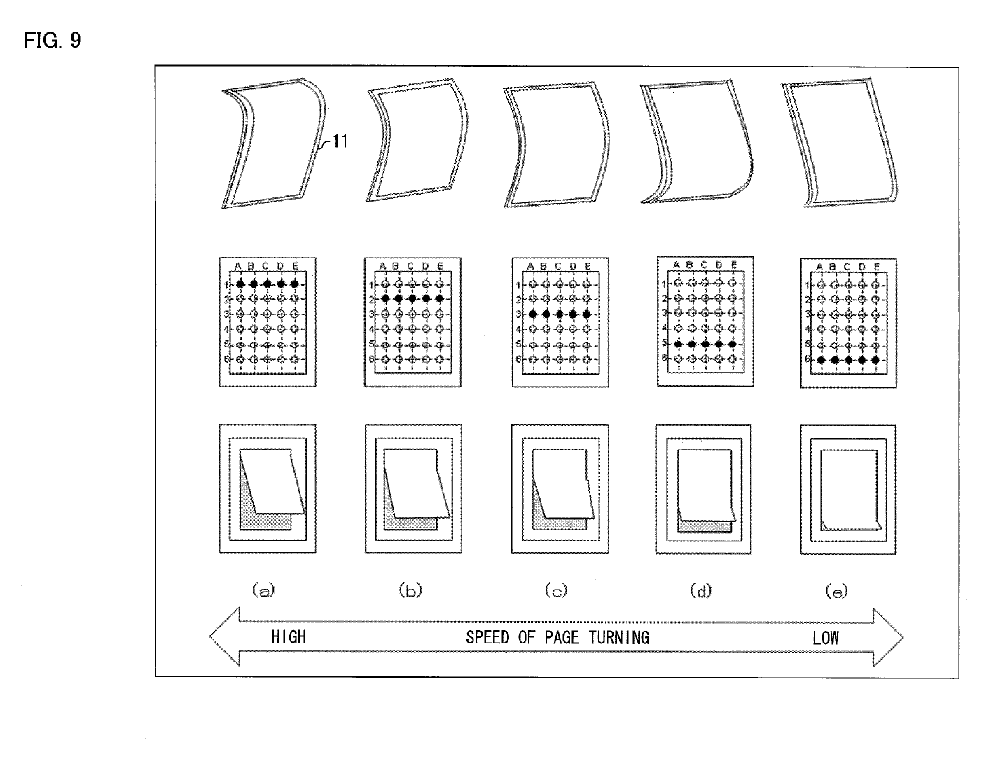

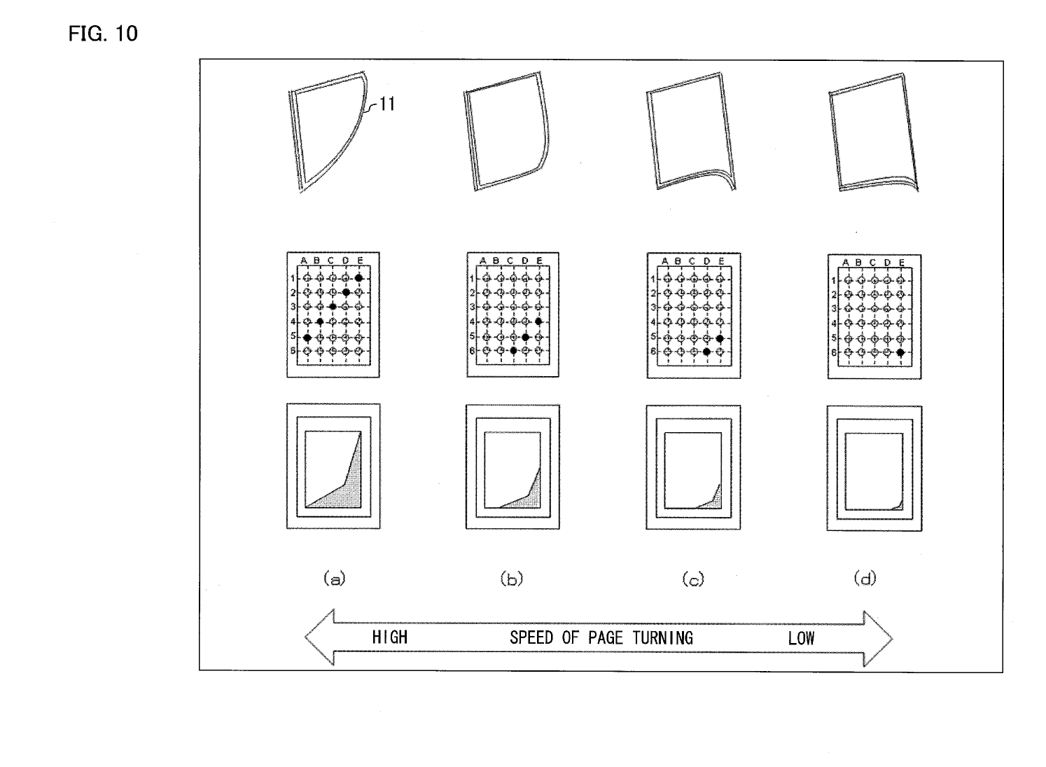

FIG. 9 and FIG. 10 are diagrams explaining other ways in which the display device 11 of Embodiment 2 of the present invention operates. The display device 11 of Embodiment 2 of the present invention includes the same pressure sensor array section 4 as that of the display device 1 of Embodiment 1. The pressure sensor array section 4 detects a bending position of the display device 11 while detecting a bending direction of the display device 11. The control section 5 is capable of carrying out page turning at a speed corresponding to the bending position. Therefore, as illustrated in FIG. 9, when bent in a vertical direction, the display device 11 of Embodiment 2 is capable of changing a speed of page turning of content in accordance with the bending position. FIG. 9 illustrates an example where the control section 5 decreases the speed of page turning as the bending position comes closer to the lower edge of the display device 11, and the control section 5 increases the speed of page turning as the bending position comes closer to the upper edge of the display device 11.

Further, as illustrated in FIG. 10, the display device 11 of Embodiment 2 is configured such that in a case where the display device 11 is bent in a diagonal direction, the control section 5 is capable of changing the speed of page turning of content in accordance with the bending position. FIG. 10 illustrates an example where in a case where the display device 11 is bent in a diagonal direction, the control section 5 decreases the speed of page turning as the bending position comes closer to the lower right edge of the display device 11, and the control section 5 increases the speed of page turning as the bending position comes closer to the upper left edge of the display device 11.

As with the display device 1 of Embodiment 1, the display device 11 of Embodiment 2, too, can change between page turning and page returning of the content to be displayed. That is, the control section 5 may be configured to control the display section 2 to carry out page turning in a case where the user bends the display device 11 so that upper and lower edges of the display device 11 move away from the user, and to control the display section 2 to carry out page returning in a case where the user bends the display device 11 so that the upper and lower edges of the display device 11 move toward the user. Further, the control section 5 may be configured to control the display section 2 to carry out page turning in a case where the user bends the display device so that the upper left and lower right edges of the display device 11 move away from the user, and to control the display section 2 to carry out page returning when the user bends the display device 11 so that the upper left and lower right edges of the display device 11 move toward the user.

As described above, the display device 11 of Embodiment 2 of the present invention is configured to, in a case where the display device 11 is bent by the user in a horizontal direction, a vertical direction, or a diagonal direction, carry out page turning or page returning of the displayed content in the bending direction. The display device 11 can carry out page turning and page returning regardless of in which direction the display device 11 is bent. This brings about an effect of enhancing the convenience of the user.

Further, the display device 11 carry out page turning or page returning at a speed determined in advance in accordance with the bending position. The display device 11 of Embodiment 2 of the present invention can change the speed of page turning in accordance with the bending position of the display device. This also brings about the effect of enhancing the convenience of the user.

### Embodiment 3

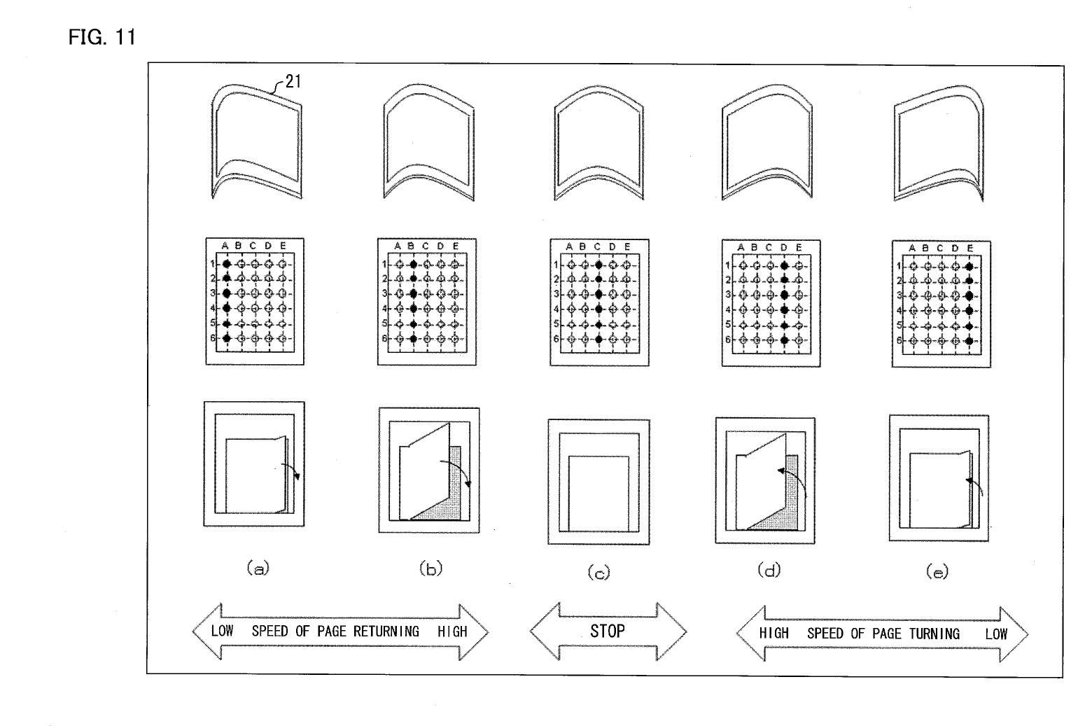

The following discusses a display device 21 of Embodiment 3 of the present invention with reference to FIGS. 1 and 11. A configuration of a main part of an invention directed to the display device 21 of Embodiment 3 is the same as that of the display device 1 of Embodiment 1, and can be carried out with reference to FIG. 1.

In the display device 1 of Embodiment 1 and the display device 11 of Embodiment 2, the control section 5 is configured (i) to control the display device 2 to carry out page turning of content in a case where the user bends the display device away from him/her, and (ii) to control the display device 2 to carry out page returning in a case where the user bends the display device toward him/her. On the other hand, the display device 21 of Embodiment 3 include a control section configured to, without determining at all whether the user bends the display device 21 away from or toward him/her, control the display section 2 is to carry out page turning or page returning of the content to be displayed. Operation of the display device 21 of Embodiment 3 is described with reference to FIG. 11. FIG. 11 illustrates how the display device 21 is displaying a horizontally-written e-book. As illustrated in (d) and (e) of FIG. 11, in a case where the display device 21 is bent at substantially the right side in a horizontal direction, the control section of the display device 21 of Embodiment 3 controls the display section 2 to carry out page turning at a speed corresponding to the bending position. Further, as illustrated in (c) of FIG. 11, in a case where the display device 2 is bent nearly at substantially the center, the control section of the display device 21 controls the display section 2 to stop page turning or page returning. Furthermore, as illustrated in (a) and (b) of FIG. 11, in a case where the display device 21 is bent at substantially the left side in a horizontal direction, the control section of the display device 21 controls the display section 2 to carry out page returning at a speed corresponding to the bending position. In any case, the pressure sensor array of the display device 21 detects only the bending position of the display device 21. That is, the control section of the display device 21 controls the display section 2 regardless of the bending direction (away from the user or toward the user) of the display device 21.

The display device 21, which is configured to change between page turning and page returning, depending on whether the display device is bent at the right or left side, brings about an effect of enhancing the convenience of the user.

### Embodiment 4

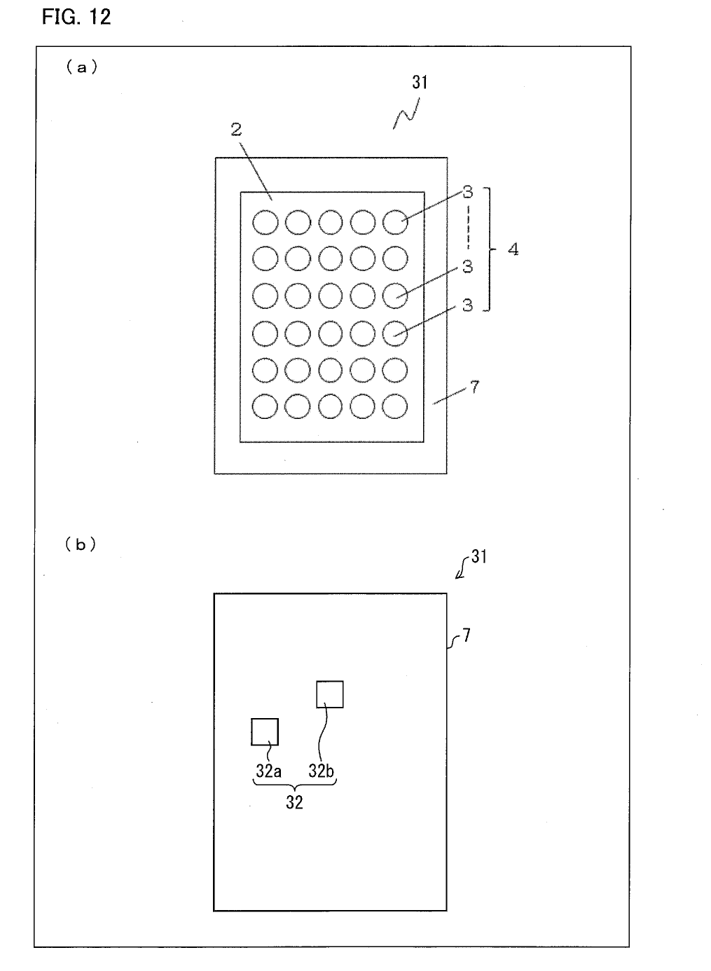

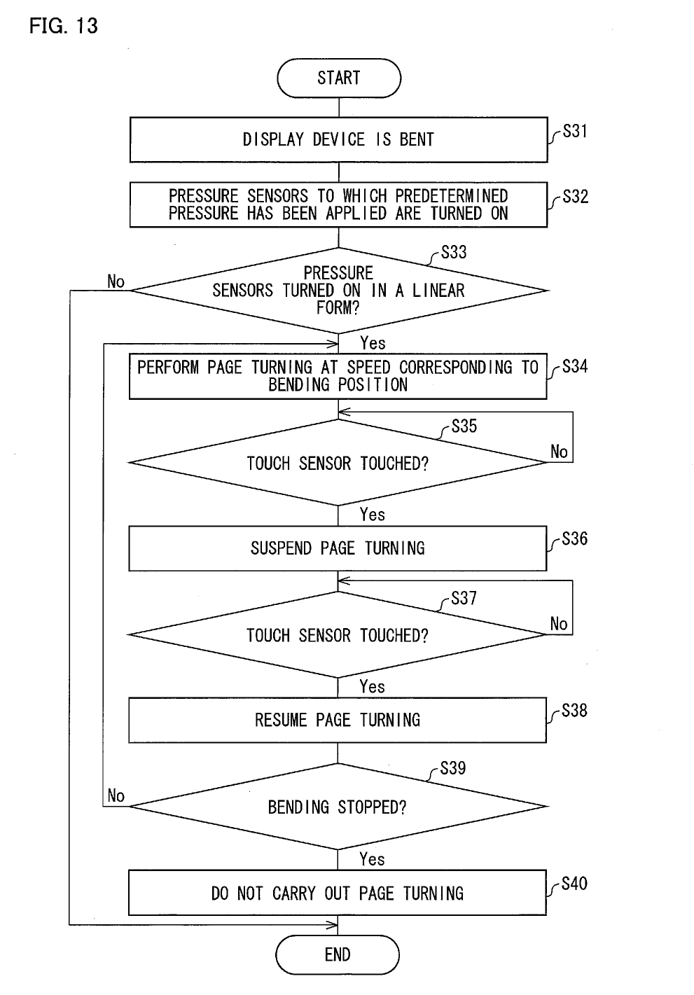

The following discusses a display device 31 according to Embodiment 4 of the present invention with reference to FIGS. 12 and 13. FIG. 12 is a set of diagrams (a) and (b) schematically illustrating a configuration of a display device 31. (a) of FIG. 12 is a front view of the display device 31. (b) of FIG. 12 is a back view of the display device 31. For a convenience of description, members having the same functions as those described in the embodiments above are given the same reference signs, and as such, are not described below.

As with the display devices described in the respective embodiments above, the display device 31, by being bent in at least in a horizontal direction, a vertical direction, or a diagonal direction, carries out page turning or page returning of the content to be displayed. The following description assumes that the display device 31 is identical in basic configuration to the display device 1 illustrated in FIGS. 1 and 2. That is, the display device 31 includes a display section 2, a pressure sensors 3, a pressure sensor array section 4, a control section 5, a storage section 6, and a substrate 7.

As illustrated in (b) of FIG. 12, the display device 31 differs from the display devices according to the respective embodiments above in that the display device 31 includes a touch sensor 32 on the back thereof. The touch sensor 32 functions as a switch to suspend or to resume page turning or page returning being performed by bending the display device 31. In Embodiment 4, the display device 31 includes two touch sensors 32, namely touch sensors 32a and 32b. The touch sensor 32a is located in a position where the user can easily touch with any finger when the user is bending the display device 31 in a horizontal direction. Meanwhile, the touch sensor 32b is located in a position where the user can easily touch with any finger when the user is bending the display device 31 in a vertical direction. That is, the touch sensor 32 is a contact detecting section configured to detect a touch of the user to operate the display device. It is preferable that the touch sensors 32a and 32b be located in places where the user rarely and accidentally touch while bending the display device 31 and where the user can easily touch if he/she will do so.

Note that the display device 31 needs only include at least one touch sensor 32, and the location of a touch sensor 32 and the number of touch sensors 32 are not limited. For example, the display device 31 may include two touch sensors 32a located in positions that are symmetrical along a horizontal direction, and two touch sensors 32b located in positions that are symmetrical along a vertical direction. Such an arrangement of the touch sensors 32a and 32b enables the user to easily touch any one of the touch sensors 32 with his/her right or left hand. Alternatively, the display device 31 may include the touch sensor 32 in a position where the user can easily touch when the user is bending the display device 31 in a diagonal direction.

By bending the display device 31, the user carries out page turning or page returning of content that the display section 2 displays. For example, while carrying out page turning of the content, the user can easily and quickly suspend the page turning of the content by touching any of the touch sensors 32. That is, the display device 31 is capable of shortening a period of time from the point in time at which the user thinks he/she would like to suspend the page turning to the point in time at which the page turning is actually suspended. With the configuration described above, a user who finds a desired page while carrying out page turning of content can easily suspend the page turning with the desired page being displayed. This, as a result, makes it possible to reduce the likelihood of a situation where excessive page turning carried out although the desired page has been found in the middle of page turning makes it necessary to carry out page returning to cause the desired page to be displayed. In this way, the display device 31 can enhance the convenience of the user.

Further, in a situation where the display device 31 is bent and in a situation where page turning or page returning of content is suspended, the user can resume the page turning or the page returning by touching any of the touch sensors 32. With the configuration described above, for example, in a case where the page turning is suspended at a page other than the desired page, the user can easily resume the page turning by simply touching the touch sensor 32. By thus making it unnecessary to resume the page turning by opening the display device (spread the display device flat) and bending the display device again. Therefore, the display device 31 can enhance the convenience of the user.

Next, an example of operation in the display device 31 is described with reference to FIG. 13. FIG. 13 is a flow chart showing an example of how the display device 31 operates. In the flowchart shown in FIG. 13, Steps S31 to S34 correspond to Steps S1 to S4 shown in FIG. 4. As such, Steps S31 to S34 are not described here.

At end of Step 34, the control section 5 controls the display section 2 to carry out page turning at a speed corresponding the bending position obtained from the pressure sensor array section 4.

In Step S35, the touch sensors 32 monitors whether there is any object touching its surface. In a case where such a contact is detected, the touch sensor 32 outputs a detection signal to the control section 5. The detection signal is associated with an operation of touching. In Embodiment 4, an object, if any, touching the surface of the touch sensor 32 is a finger of the user, the touch sensor 32 can be rephrased as detecting whether or not the user has touched its surface. In a case where the touch sensor 32 does not detect such a contact (No in S35), the touch sensor 32 does not output a detection signal, so that the control section 5 controls the display section 2 to continue the page turning. On the other hand, in a case where the touch sensor 32 detects such a contact (Yes in S35), the touch sensor 32 outputs a detection signal to the control section 5. Upon receiving the detection signal from the touch sensor 32, the control section 5 controls the display section 2 to suspend the page turning (S36).

Even while the page turning is suspended, the touch sensor 32 monitors whether there is any object touching its surface (S37). In a case where the touch sensor 32 does not detect such a contact (No in S37), the touch sensor 32 does not output a detection signal, so that the control section 5 controls the display section 2 to continue suspending the page turning. On the other hand, in a case where the touch sensor 32 detects such a contact (Yes in S37), the touch sensor 32 outputs a detection signal to the control section 5. Upon receiving the detection signal from the touch sensor 32, and the control section 5 controls the display section 2 to resume the page turning (S38).

Steps S39 and S40 correspond to Steps S6 and S7 of FIG. 4, and as such are not described here.

In Embodiment 4, the flow of suspension and resumption via the touch sensor 32 has been described by taking the case of page turning as an example. However, the flow is also applicable to the case of page returning.

### Embodiment 5

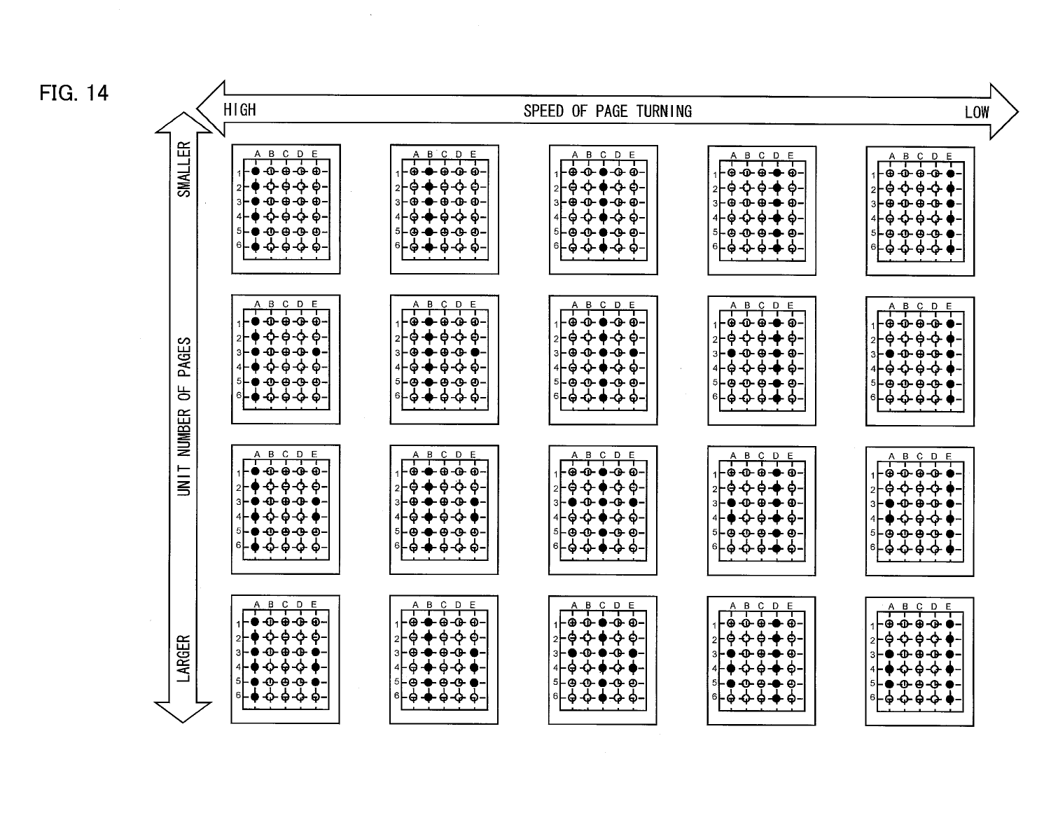

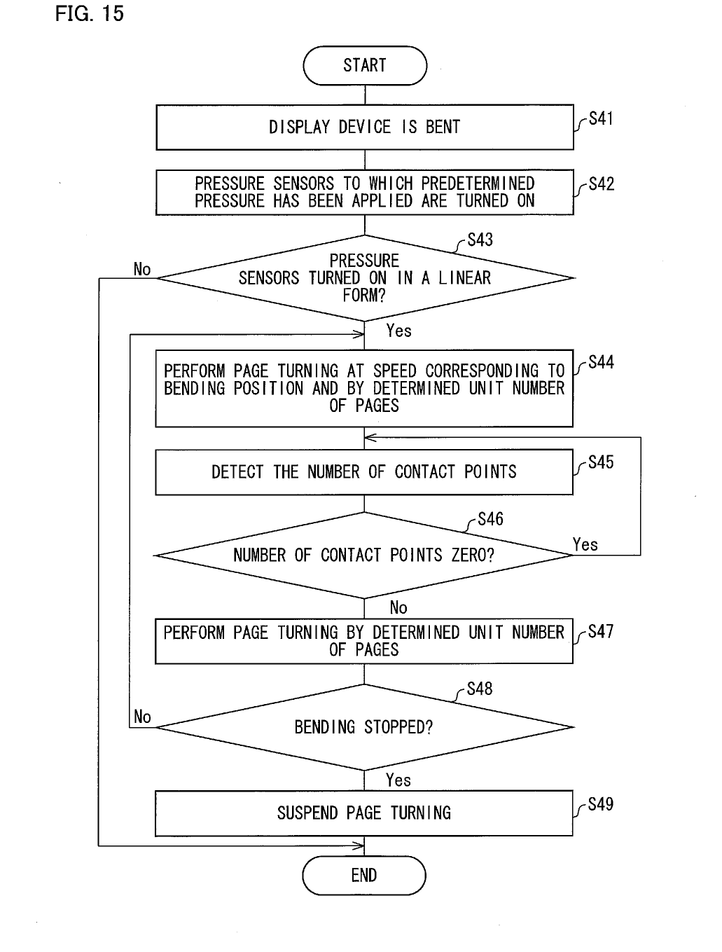

The following discusses a display device 41 according to Embodiment 5 of the present invention with reference to FIGS. 14 and 15. FIG. 14 is a diagram explaining an example of how the display device 41 operates. For convenience of description, members having the same functions as those described in the embodiments above are given the same reference signs, and as such, are not described below.

As with the display devices described in Embodiments 1 through 3, the display device 41, by being bent in at least in a horizontal direction, a vertical direction, or a diagonal direction, carries out page turning or page returning of the content to be displayed. The following description assumes that the display device 41 is identical in basic configuration to the display device 1 illustrated in FIGS. 1 and 2. That is, the display device 31 includes a display section 2, a pressure sensors 3, a pressure sensor array section 4, a control section 5, a storage section 6, and a substrate 7.

When the display section 41 is bent in a horizontal direction, the control section 5 controls the display section 2 to carry out page turning or page returning at a speed corresponding to the bending position. In Embodiment 5, the operation of the display device 41 is described by taking page turning as an example. The display device 41 illustrated in the highest row of FIG. 14 corresponds to the state of the display device 1 illustrated in the middle row of FIG. 3. That is, in a state in which the display device 41 is bent nearly at the left edge and the pressure sensors 3 in rows 1 to 6 in column A are turned on, the control section 5 controls the display section 2 to carry out page turning at the fastest speed of the speeds determined in advance. Further, as the bending position of the display device 41 comes from the left edge closer to the right edge of the display device 41, the control section 5 controls the display device 2 to decrease the speed of page turning.

In addition to detecting a bending position as described above, the pressure sensor array section 4 of the display device 41 is configured to detect the number of pressure sensors 3 that are turned on in an area excluding the bending position. In the area excluding the bending position, the pressure sensors 3 are turned on when the user touches such an area with a finger. In a case where the user touches the area excluding the bending position on the display section 2 with one finger, one of the pressure sensors 3 is turned on. Similarly, in a case where the user touches the area with two fingers, two of the pressure sensors 3 are turned on, and in a case where the user touches the area with three fingers, three of the pressure sensors 3 are turned on.

In a case where the user touches the display section 2 with a plurality of fingers, the user may touch with fingers of one hand, or with fingers of both hands. In Embodiment 5, the clause “the user turns on the pressure sensors 3 via the display section 2” means that an operation is inputted from outside of the display device 41. Hence, the pressure sensor array section 4, in which a plurality of the pressure sensors 3 are arranged in a matrix form, is a contact detecting section.

The pressure sensor array section 4 outputs, to the control section 5, the bending position and the number of pressure sensors 3 that are turned on in the area excluding the bending position. In the following description, the number of pressure sensors 3 that are turned on in the area excluding the bending position may also be expressed as the number of contact points. The number of contact points is a detection signal associated with a contact from outside by the user.

The highest row of FIG. 14 illustrates the display device 41 in a case where the number of contact points is 0. In this case, the control section 5 controls the display section 2 to carry out page turning page by page, regardless of whether the speed of page turning is high or low. In the following description, the number of pages by page turning is carried out is expressed as the unit number of pages. In a case where the number of contact points is 0, the unit number of pages is 1.

The second row from the top of FIG. 14 illustrates the display device 41 in a case where the number of contact points is 1. The third row from the top of FIG. 14 illustrates the display device 41 in a case where the number of contact points is 2. The lowest row of FIG. 14 illustrates the display device 41 in a case where the number of contact points is 3. Regardless of whether the speed of page turning is high or low, the control section 5 controls the display section 2 to carry out page turning by the unit number of pages of 10 when the number of contact points is 1, the unit number of pages of 20 when the number of contact points is 2, or the unit number of pages of 30 when the number of contact points is 3.

According to the configuration described above, the display device 41 is configured to, in carrying out page turning of content, be able to change the speed of page turning and the unit number of pages independently of each other. The speed of page turning and the unit number of pages are parameters that exert influence on the appearance of transition on the display section 2, but exert influence on the appearance of transition on the display section 2 in different ways. Since the speed of page turning and the unit number of pages can be changed independently of each other, the user can change the appearance of transition on the display section 2 in accordance with his/her preference. In other words, in carrying out page turning, the display device 41 can reflect the user's preference more faithfully. Therefore, the display device 41 can enhance the convenience of the user when the user looks for a desired page in the content that he/she views.

Note that the display device 41 is not limited to the example illustrated in FIG. 14 in terms of where on the display section 2 the user touches to change the number of contact points. Further, while Embodiment 5 has been described by taking, as an example, a case where a maximum number of contact points is 3, but the maximum number of contact points is not limited to 3. Further, the unit number of pages that is associated with each number of contact points is not limited, either.

Further, the control section 5 may be configured such that the unit number of pages by which page turning is carried out and the unit number of pages by which page returning is carried out can be set separately from each other. For example, the unit numbers of pages corresponding to the numbers of contact points 0 to 3 may be set to 1, 10, 20 and 30 pages for page turning and may be set to 1, 3, 6 and 9 pages for page returning.

Next, an example of operation in the display device 41 is described with reference to FIG. 15. FIG. 15 is a flow chart showing an example how the display device 41 operates. In the flow shown in FIG. 15, Steps S41 to S43 corresponds to Steps S1 to S3 shown in FIG. 4. As such, Steps 41 to 43 are not described here.

In Step S44, the control section 5 controls the display section 2 to carry out page turning at a speed corresponding to the bending position obtained from the pressure sensor array section 4 and by a predetermined unit number of pages. The unit number of pages at the start of page turning needs only be appropriately determined. In Embodiment 5, it is assumed that the unit number of pages at the start of page turning is one.

In Step S45, the pressure sensor array section 4 detects the number of contact points and outputs it to the control section 5. Therefore, the control section 5 determines whether or not the number of contact points obtained from the pressure sensor array section 4 is 0 (S46).

In a case where the number of contact points is 0 (Yes in S46), the control section 5 controls the display section 2 to continue carrying out page turning. On the other hand, in a case where the number of contact points is not 0 (No in S46), the control section 5 controls the display section 2 to carry out page turning by a predetermined unit number of pages corresponding to the number of contact points (S47). Specifically, the control section 5 controls the display section 2 to carry out page turning by the unit number of pages of 10 when the number of contact points is 1, the unit number of pages of 20 when the number of contact points is 2, or the unit number of pages of 30 when the number of contact points is 3.

Steps S48 and S49 correspond to Steps S6 to S7 of FIG. 4, and as such, are not described here.

In Embodiment 5, the flow of changing the unit number of page in accordance with the number of contact points has been described by taking, as an example, the case of page turning. However, this flow is also applicable to the case of page returning.

[Summary]

A display device according to Aspect 1 of the present invention is a display device for displaying information, the display device including: a display section for displaying information; a pressure sensor array section constituted by a plurality of pressure sensors arranged in a matrix form; and a control section for controlling a speed of page turning of information to be displayed, the pressure sensor array section outputting a pressure change to the control section together with a position of the display device, the control section carrying out page turning at a speed corresponding to the position.

In Aspect 1, a display device according to Aspect 2 of the present invention is preferably configured such that: in a case where a bending position of the display device is close to one edge of the display device, the display device increases the speed of page turning of the information to be displayed; and in a case where the bending position of the display device is close to the other edge of the display device, the display device decreases the speed of page turning of the information to be displayed.

In Aspect 2, a display device according to Aspect 3 of the present invention is preferably configured such that the pressure sensor array section is capable of detecting a bending of the display device regardless whether a bending direction of the display device is a horizontal direction, a vertical direction, or a diagonal direction.

In Aspect 3, a display device according to Aspect 4 of the present invention is preferably configured such that the pressure sensor array section is capable of changing a direction of page turning, depending on whether the display device is so bent that the edges move to a near side or a far side.

A method for a display according to Aspect 5 of the present invention is a method for a display on a display device configured to carry out a display step of displaying information, a bending detection step of detecting a bending of a housing, and a display control step of scrolling information to be displayed, the method including the step of carrying out, at a speed corresponding to a bending position of the housing that has been detected in the bending detection step, page turning of the information to be displayed.

A display device according to Aspect 6 of the present invention is a display device for displaying information, the display device including: a display section for displaying information; a pressure sensor array section constituted by a plurality of pressure sensors arranged in a matrix form; and a control section for controlling a display of information, the pressure sensor array section being capable of detecting a bending of the display device regardless of whether a bending direction of the display device is a horizontal direction, a vertical direction, or a diagonal direction, in accordance with the detection by the pressure sensor array section, the control section carrying out, in the bending direction of the display device, page turning of information to be displayed. In Aspect 6, a display device according to Aspect 7 of the present invention is preferably configured such that: the pressure sensor array section detects a bending position of the display device; in a case where the bending direction of the display device is a horizontal direction and the information to be displayed is horizontally written, the control section carries out page turning of a right side of the bending position of the display device; and in a case where the bending direction of the display device is a horizontal direction and the information to be displayed is vertically written, the control section carries out page turning of a left side of the bending position of the display device.

In Aspect 7, a display device according to Aspect 8 of the present invention is preferably configured such that the control section carries out, at a speed determined in accordance with the bending position detected by the pressure sensor array section, page turning of information to be displayed.

In Aspect 8, a display device according to Aspect 9 of the present invention is preferably configured such that the pressure sensor array section is capable of changing a direction of page turning, depending on whether the display device is so bent that edges of the display device move to a near side or a far side.

A method for a display according to Aspect 10 of the present invention is a method for a display on a display device configured to carry out a display step of displaying information, a bending detection step of detecting a bending of the display device, and a display control step of scrolling information to be displayed, in a case where, as a result of the detection in the bending detection step, a bending direction of the display device is a horizontal direction, a vertical direction, or a diagonal direction, the display control step carries out page turning of the information to be displayed.

In any one of Aspects 2 to 4 and 7 to 9, a display device according to Aspect 11 of the present invention is preferably configured to further include a contact detecting section for, upon detecting a contact from outside, outputting a detection signal corresponding to the contact, wherein the control section carries out the page turning at a speed corresponding the bending position and the detection signal obtained from the contact detecting section.

With the configuration described above, the display device according to Aspect 11 of the present invention includes: a pressure sensor array section for, upon detecting a bending of the display device, outputting a bending position of the display device to the control section; and a contact detecting section for, upon detecting a contact from outside, outputting, to the control section, a detection signal corresponding to the contact. The control section controls, in accordance with the bending position and the detection signal, a display section to carry out page turning. That is, a user can operate the page turning by a simple operation of touching the contact detecting section while bending the display device. Therefore, the display device brings about an effect of enhancing the convenience of the user.

In Aspect 11, a display device according to Aspect 12 of the present invention is preferably configured such that, upon receiving the detecting signal while controlling the display section to carry out the page turning, the control section controls the display section to suspend the page turning.

With the configuration described above, a user who finds a desired page while carrying out page turning, can easily suspend the page turning with the desired page being displayed. This, as a result, makes it possible to reduce the likelihood of a situation where excessive page turning carried out although the desired page has been found in the middle of page turning makes it necessary to carry out page returning to cause the desired page to be displayed. In this way, the display device can enhance the convenience of the user.

In Aspect 12, a display device according to Aspect 13 of the present invention is preferably configured such that, upon receiving the detection signal while controlling the display section to suspend the page turning, the control section controls the display section to resume the page turning.

With the configuration described above, it is unnecessary to resume the page turning by opening the display device (spread the display device flat) and bending the display device again. Therefore, the display device can enhance the convenience of the user.

In Aspect 11, a display device according to Aspect 14 of the present invention is configured such that: upon detecting the contact, the contact detecting section outputs a detection signal representing the number of contact points; and upon receiving the detection signal while controlling the display section to carry out the page turning, the control section controls the display section to carry out the page turning by the number of pages corresponding to the detection signal.

The speed of page turning and the unit number of pages are parameters that exert influence on the appearance of transition on the display section, but, during page turning, exert influence on the appearance of transition on the display section in different ways. Since the speed of page turning and the unit number of pages can be changed independently of each other, the user can change the appearance of transition on the display section in accordance with his/her preference. In other words, in carrying out page turning, the display device can reflect the user's preference more faithfully. Therefore, according to the configuration described above, the display device can enhance the convenience of the user when the user looks for a desired page in the content that he/she views.

The present invention is not limited to the description of the embodiments above, but may be altered by a skilled person within the scope of the claims. An embodiment based on a proper combination of technical means disclosed in different embodiments is encompassed in the technical scope of the present invention. Further, the technical means disclosed in different embodiments can be combined so as to form a new technical feature.

### INDUSTRIAL APPLICABILITY

The present invention is applicable to a display device.

### REFERENCE SIGNS LIST

1, 11, 21, 31, and 41 Display device
2 Display section
3 Pressure sensor
4 Pressure sensor array section
5 Control section
6 Storage section
7 Substrate
101 Display section
102 Input section
103 Communication section
104 Sensor section
105 Voice output section
106 Arithmetic section
107 Data storage section such as hard disc
108 Storage section
109 Information reading program
110 Data folder
111 Web browser
112 Internet web
113 WWW server
114 Content control server

1. A display device for displaying information, the display device comprising:
a display section for displaying information;
a pressure sensor array section constituted by a plurality of pressure sensors arranged in a matrix form; and
a control section for controlling a speed of page turning of information to be displayed,
the pressure sensor array section outputting a pressure change to the control section together with a bending position of the display device,
the control section carrying out page turning at a speed corresponding to the bending position.

2. The display device as set forth in claim 1, wherein:
in a case where the bending position is close to one edge of the display device, the display device increases the speed of page turning of the information to be displayed; and
in a case where the bending position of the display device is close to the other edge of the display device, the display device decreases the speed of page turning of the information to be displayed.

3. The display device as set forth in claim 2, wherein the pressure sensor array section is capable of detecting a bending of the display device regardless whether a bending direction of the display device is a horizontal direction, a vertical direction, or a diagonal direction.

4. The display device as set forth in claim 3, wherein the pressure sensor array section is capable of changing a direction of page turning, depending on whether the display device is so bent that the edges move to a near side or a far side.

5. A method for a display on a display device configured to carry out a display step of displaying information, a bending detection step of detecting a bending position of a housing, and a display control step of scrolling information to be displayed,
the method comprising the step of carrying out, at a speed corresponding to the bending position of the housing that has been detected in the bending detection step, page turning of the information to be displayed.

6. A display device for displaying information, the display device comprising:
a display section for displaying information;
a pressure sensor array section constituted by a plurality of pressure sensors arranged in a matrix form; and
a control section for controlling a display of information,
the pressure sensor array section being capable of detecting a bending of the display device regardless of whether a bending direction of the display device is a horizontal direction, a vertical direction, or a diagonal direction,
in accordance with the detection by the pressure sensor array section, the control section carrying out, in the bending direction of the display device, page turning of information to be displayed.

7. The display device as set forth in claim 6, wherein:
the pressure sensor array section detects a bending position of the display device;
in a case where the bending direction of the display device is a horizontal direction and the information to be displayed is horizontally written, the control section carries out page turning of a right side of the bending position; and
in a case where the bending direction of the display device is a horizontal direction and the information to be displayed is vertically written, the control section carries out page turning of a left side of the bending position.

8. The display device as set forth in claim 7, wherein the control section carries out, at a speed determined in accordance with the bending position detected by the pressure sensor array section, page turning of information to be displayed.

9. The display device as set forth in claim 8, wherein the pressure sensor array section is capable of changing a direction of page turning, depending on whether the display device is so bent that edges of the display device move to a near side or a far side.

10. A method for a display on a display device configured to carry out a display step of displaying information, a bending detection step of detecting a bending of the display device, and a display control step of scrolling information to be displayed,
in a case where, as a result of the detection in the bending detection step, a bending direction of the display device is a horizontal direction, a vertical direction, or a diagonal direction, the display control step carries out page turning of the information to be displayed.

11. The display device as set forth in claim 2, further comprising a contact detecting section for, upon detecting a contact from outside, outputting a detection signal corresponding to the contact, wherein
the control section carries out the page turning at a speed corresponding the bending position and the detection signal obtained from the contact detecting section.

12. The display device as set forth in claim 11, wherein upon receiving the detecting signal while controlling the display section to carry out the page turning, the control section controls the display section to suspend the page turning.

13. The display device as set forth in claim 12, wherein upon receiving the detection signal while controlling the display section to suspend the page turning, the control section controls the display section to resume the page turning.

14. The display device as set forth in claim 11, wherein:
upon detecting the contact, the contact detecting section outputs a detection signal representing the number of contact points; and
upon receiving the detection signal while controlling the display section to carry out the page turning, the control section controls the display section to carry out the page turning by the number of pages corresponding to the detection signal.

15. The display device as set forth in claim 7, further comprising a contact detecting section for, upon detecting a contact from outside, outputting a detection signal corresponding to the contact, wherein
the control section carries out the page turning at a speed corresponding the bending position and the detection signal obtained from the contact detecting section.

16. The display device as set forth in claim 15, wherein upon receiving the detecting signal while controlling the display section to carry out the page turning, the control section controls the display section to suspend the page turning.

17. The display device as set forth in claim 16, wherein upon receiving the detection signal while controlling the display section to suspend the page turning, the control section controls the display section to resume the page turning.

18. The display device as set forth in claim 15, wherein:
upon detecting the contact, the contact detecting section outputs a detection signal representing the number of contact points; and
upon receiving the detection signal while controlling the display section to carry out the page turning, the control section controls the display section to carry out the page turning by the number of pages corresponding to the detection signal.
